(19) United States
(12) Patent Application Publication
(10) Pub. No.: US 2021/0142213 A1
(43) Pub. Date: May 13, 2021

(54) Data Partitioning with Quality Evaluation

(71) Applicant: International Business Machines Corporation, Armonk, NY (US)

(72) Inventors: Si Er Han, Xi'an (CN); Steven George Barbee, Amenia, NY (US); Jing Xu, Xi'an (CN); Ji Hui Yang, Beijing (CN); Xue Ying Zhang, Xi'an (CN)

(21) Appl. No.: 16/681,920

(22) Filed: Nov. 13, 2019

(51) Int. Cl. G06N 20/00; G06N 5/04; G06F 16/28; G06F 16/2457

(52) U.S. Cl. CPC G06N 20/00; G06F 16/24578; G06F 16/285; G06N 5/04

(57) ABSTRACT

Evaluating data partition quality is provided. A historical data set is partitioned into a specified number of partitions. A quality of each partition in the specified number of partitions is evaluated by measuring a distribution similarity between variables from each data subset in a respective partition and the historical data set. A highest-quality partition in the specified number of partitions is recommended to build a supervised machine learning model based on the highest-quality partition having a highest variable distribution similarity measure with the historical data set.

### BACKGROUND

### 1. Field

The disclosure relates generally to machine learning and more specifically to evaluating quality of data partitions to determine whether variable distribution of each partition data subset is similar to a historical data set using distribution similarity measures to recommend a highest-quality data partition to build, validate, and test a supervised machine learning model corresponding to the historical data set.

### 2. Description of the Related Art

Machine learning is the science of getting computers to act without being explicitly programmed. In other words, machine learning is a method of data analysis that automates analytical model building. Machine learning is a branch of artificial intelligence based on the idea that computer systems can learn from data, identify patterns, and make decisions with minimal human intervention.

The majority of machine learning uses supervised learning. Supervised learning is the task of learning a function that maps an input to an output based on example input-output pairs. Supervised learning infers a function from labeled training data consisting of a set of training examples. Each example is a pair consisting of an input object, which is typically a vector, and a desired output value (e.g., a supervisory signal).

A supervised learning algorithm analyzes the training data and produces an inferred function, which can be used for mapping new examples. An optimal scenario allows the supervised learning algorithm to correctly determine the class labels for unseen data. This requires the supervised learning algorithm to generalize from the training data to unseen data in a “reasonable” way (e.g., inductive bias).

The term supervised learning comes from the idea that the algorithm is learning from a training data set, which can be thought of as the teacher. The algorithm iteratively makes predictions on the training data and is corrected by the teacher. Learning stops when the algorithm achieves an acceptable level of performance.

In machine learning, supervised models are usually fitted on historical or original data consisting of input (i.e., predictor) data and output (i.e., target) data. Then, the supervised models are applied to new input data to predict the output. During this process, the historical data set is often randomly partitioned into subsets, such as, for example, a training data subset, a validation data subset, and a testing data subset. The training data subset is used to build the supervised machine learning model. The validation data subset set is used to fine-tune hyper-parameters of the supervised machine learning model or select the best supervised machine learning model for supervised learning.

Once the final supervised machine learning model is built, the performance of the supervised machine learning model is evaluated on the testing data subset, which is not used during the building of the supervised machine learning model. If a data analyst does not want to fine-tune hyper-parameters or to select the supervised building model, then the validation data subset is not needed, and the historical data set is just partitioned into training data and testing data subsets.

Currently, most machine learning software perform data partitioning using random sampling methods based on a specified percentage of training, validation, and testing data subsets. However, deficiencies exist in random sampling methods. For example, random sampling methods fail to provide similar variable distribution as the historical data set.

For imbalanced data, to ensure that the class distribution in each data subset is the same as in the whole historical data set (i.e., distribution consistency), stratified sampling methods can be used. However, deficiencies also exist in stratified sampling methods. For example, stratified sampling is complicated and inefficient when a large number of categorical variables exist because stratified sampling needs to find all possible combinations of categories, and then perform the sampling in each combination. For continuous variables with skewed distribution, stratified sampling cannot ensure that the distribution of each data subset is the same as the whole historical data set. As a result, it is difficult for a user to build a high-quality supervised machine learning model using current sampling methods, even if the user spends a lot of time refining the model.

### SUMMARY

According to one illustrative embodiment, a computer-implemented method for evaluating data partition quality is provided. A computer partitions a historical data set into a specified number of partitions. The computer evaluates a quality of each partition in the specified number of partitions by measuring a distribution similarity between variables from each data subset in a respective partition and the historical data set. The computer recommends a highest-quality partition in the specified number of partitions to build a supervised machine learning model based on the highest-quality partition having a highest variable distribution similarity measure with the historical data set. According to other illustrative embodiments, a computer system and computer program product for evaluating data partition quality are provided.

In addition, illustrative embodiments randomly partition the historical data set a specified number of times to generate the specified number of partitions divided into a specified number of data subsets according to a percentage specified for each respective data subset. Illustrative embodiments also perform a projection of a specified number of projections for variables of the historical data set and for variables of each data subset and generate, during the projection, a random weight for the variables of the historical data set and for the variables of each data subset to form a weighted linear combination for the projection. Variables from each data subset and the historical data set are one of categorical variables and continuous variables. Further, illustrative embodiments generate a single new variable for variables of the historical data set and for variables of each data subset based on the weighted linear combination of the projection corresponding to the historical data set and each data subset, calculate a distribution similarity measure between the historical data set and each data subset based on significant p values of a statistical test that measured the distribution similarity between the single new variable of the historical data set and each data subset, and average distribution similarity measures of the specified number of data subsets to form an average distribution similarity measure for the projection.

Moreover, illustrative embodiments collect average distribution measures for the specified number of projections to form a specified number of average distribution similarity measures and calculate a partition quality score for a selected data partition based on one of a mean, median, or z-score of the specified number of average distribution similarity measures. Illustrative embodiments select a particular partition having a highest partition quality score and determine whether the highest partition quality score is greater than a minimum partition quality score threshold. In response to determining that the highest partition quality score is greater than the minimum partition quality score threshold, illustrative embodiments use the particular partition having the highest partition quality score to build, validate, and test the supervised machine learning model corresponding to the historical data set. In response to determining that the highest partition quality score is less than or equal to the minimum partition quality score threshold, illustrative embodiments send a recommendation to a user to include more data in the set of data partitions to increase partition quality.

As a result, illustrative embodiments determine whether each data subset of a particular data partition corresponding to the historical data set has a similar variable distribution as the historical data set. In addition, illustrative embodiments work with categorical variables and continuous variables. Further, illustrative embodiments provide quality scores for each data partition corresponding to the historical data set, which assist users in understanding whether a particular data partition can be used directly to build the supervised machine learning model corresponding to the historical data set or whether more data should be collected to increase quality of data partitions. Furthermore, illustrative embodiments identify quality data partitions corresponding to a historical data set and recommend a highest-quality data partition to a user for building the supervised machine learning model. Moreover, illustrative embodiments utilize the highest-quality data partition to build, validate, and test the supervised machine learning model corresponding to the historical data set. Thus, illustrative embodiments increase performance of the supervised machine learning model corresponding to the historical data set by utilizing the highest-quality data partition to build, validate, and test the supervised machine learning model, which enables the supervised machine learning model to predict unseen data more effectively.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an overview of data partition recommendation process in accordance with an illustrative embodiment;

FIG. 4 is a diagram illustrating an example of a data partition process in accordance with an illustrative embodiment;

FIG. 5 is a diagram illustrating an example of a partition quality evaluation process in accordance with an illustrative embodiment;

FIG. 6 is a diagram illustrating an example of a variable distribution similarity measuring process in accordance with an illustrative embodiment;

FIG. 7 is a diagram illustrating an example of a data partition summary table in accordance with an illustrative embodiment;

FIG. 8 is a flowchart illustrating a process for recommending a quality data partition for building a supervised machine learning model in accordance with an illustrative embodiment; and

FIGS. 9A-9C are a flowchart illustrating a process for evaluating data partition quality in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. In addition, server 104 and server 106 provide data partition quality evaluation services to client device users. For example, server 104 and server 106 evaluate the quality of data partitions corresponding to a historical data set to determine whether variable distribution of each data subset of each data partition is similar to the historical data set in order to recommend a highest-quality data partition to build, validate, and test a supervised machine learning model corresponding to the historical data set. Also, server 104 and server 106 may represent a cluster of servers in one or more data centers. Alternatively, server 104 and server 106 may represent computing nodes in one or more cloud environments.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, laptop computers, handheld computers, smart phones, smart televisions, and the like, with wire or wireless communication links to network 102. Users of clients 110, 112, and 114 may utilize clients 110, 112, and 114 to access and utilize the data partition quality evaluation services provided by server 104 and server 106.

Storage 108 is a network storage device capable of storing any type of data in a structured format or an unstructured format. In addition, storage 108 may represent a plurality of network storage devices. Further, storage 108 may store one or more historical data sets corresponding to one or more entities, such as, for example, companies, businesses, enterprises, organizations, institutions, agencies, and the like. Each historical data set may be related to a particular domain, such as, for example, an insurance domain, a banking domain, a healthcare domain, a financial domain, a banking domain, an entertainment domain, a business domain, or the like.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis or a persistent basis. Further, a computer readable storage device excludes a propagation medium. Memory 206, in these examples, may be, for example, a random-access memory (RAM), or any other suitable volatile or non-volatile storage device. Persistent storage 208 may take various forms, depending on the particular implementation. For example, persistent storage 208 may contain one or more devices. For example, persistent storage 208 may be a disk drive, a solid-state drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores data partition quality manager 218. However, it should be noted that even though data partition quality manager 218 is illustrated as residing in persistent storage 208, in an alternative illustrative embodiment data partition quality manager 218 may be a separate component of data processing system 200. For example, data partition quality manager 218 may be a hardware component coupled to communication fabric 202 or a combination of hardware and software components. In another alternative illustrative embodiment, a first set of components of data partition quality manager 218 may be located in data processing system 200 and a second set of components of data partition quality manager 218 may be located in a second data processing system, such as, for example, server 106 in FIG. 1.

Data partition quality manager 218 controls the process of evaluating quality of data partitions corresponding to historical data set 220 to ensure that variable distribution of data subsets of a data partition is similar to historical data set 220 using distribution similarity measures. Historical data set 220 represents an original body of information corresponding to particular entity, such as a client or customer. Historical data set 220 may be stored in a remote storage, such as, for example, storage 108 in FIG. 1, or may be stored locally in persistent storage 208.

Historical data set 220 includes variables 222. Variables 222 represents a plurality of variables corresponding to the original body of information of the particular entity. A variable is a value that may be changed.

Data partition quality manager 218 randomly partitions historical data set 220 into a plurality of data partitions. A user of a client device, such as, for example, client 110 in FIG. 1, specifies the number of data partitions to partition historical data set 220 into. Partition 224 represents one of the plurality of data partitions corresponding to historical data set 220. Partition 224 includes data subsets 226. Data subsets 226 represent a plurality of data subsets, such as, for example, three data subsets. The three data subsets may be, for example, a training data subset, a validation data subset, and a testing data subset. However, it should be noted that different illustrative embodiments are limited to three data subsets. For example, different illustrative embodiments may utilize k-fold cross-validation, which partitions historical data set 220 into k number of data subsets.

Data partition quality manager 218 divides partition 224 into data subsets 226 according to percentage 228. Percentage 228 represents a percentage amount of data, such as, for example, 50%, from historical data set 220 to include in a particular data subset. In other words, a size of a given data subset in data subsets 226 is defined by percentage 228. The user of the client device specifies percentage 228 for each respective data subset in data subsets 226. For example, the user may specify that a first data subset include 50% of historical data set 220, a second data subset include 25% of historical data set 220, and a third data subset also include 25% of historical data set 220. As a result, each respective data subset in data subsets 226 includes a different group of variables 230.

Data partition quality manager 218 determines whether variables 230 of each different data subset in data subsets 226 are the same or similar to variables 222 of historical data set 220 based on distribution similarity measure 232. Distribution similarity measure 232 represents a level or degree of similarity between variables 230 of a particular data subset in data subsets 226 and variables 222 of historical data set 220. In other words, data partition quality manager 218 computes a distribution similarity measure for each respective data subset in data subsets 226. Further, data partition quality manager 218 generates partition quality score 234 for partition 224 by, for example, averaging distribution similarity score 232 of each respective data subset in data subsets 226. However, it should be noted that different illustrative embodiments are not limited to averaging. In other words, different illustrative embodiments may utilize mean, median, or other methods, such as z-score or standard score, which is a mean divided by a standard deviation or mean divided by a range (e.g., interquartile range).

Data partition quality manager 218 repeats this process for each partition in the plurality of partitions corresponding to historical data set 220. Afterward, data partition quality manager 218 generates partition summary table 236. Partition summary table 236 includes an entry for each respective data partition in the plurality of data partitions corresponding to historical data set 220. Each data partition entry may include distribution similarity measure 232 of each data subset and partition quality score 234 corresponding to that particular data partition. Further, partition summary table 236 may include a recommendation as to which data partition in the plurality of data partitions should be used to build a supervised machine learning model corresponding to historical data set 220. Data partition quality manager 218 may recommend the data partition having the highest partition quality score 234.

Data partition quality manager 218 sends partition summary table 236 to the client device of the user for the user's review and possible selection of a data partition to build the supervised machine learning model corresponding to historical data set 220. However, it should be noted that in an alternative illustrative embodiment, data partition quality manager 218 may automatically select the highest scoring data partition to build, validate, and test the supervised machine learning model corresponding to historical data set 220. Also, it should be noted that data partition quality manager 218 may ensure that the score of the highest scoring data partition is greater than a defined minimum score threshold before selecting that data partition to automatically build the supervised machine learning model.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 238 is located in a functional form on computer readable media 240 that is selectively removable and may be loaded onto or transferred to data processing system 200 for running by processor unit 204. Program code 238 and computer readable media 240 form computer program product 242. In one example, computer readable media 240 may be computer readable storage media 244 or computer readable signal media 246. Computer readable storage media 244 may include, for example, an optical or magnetic disc that is inserted or placed into a drive or other device that is part of persistent storage 208 for transfer onto a storage device, such as a hard drive, that is part of persistent storage 208. Computer readable storage media 244 also may take the form of a persistent storage, such as a hard drive, a thumb drive, or a flash memory that is connected to data processing system 200. In some instances, computer readable storage media 244 may not be removable from data processing system 200.

Alternatively, program code 238 may be transferred to data processing system 200 using computer readable signal media 246. Computer readable signal media 246 may be, for example, a propagated data signal containing program code 238. For example, computer readable signal media 246 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 238 may be downloaded over a network to persistent storage 208 from another device or data processing system through computer readable signal media 246 for use within data processing system 200. For instance, program code stored in a computer readable storage media in a data processing system may be downloaded over a network from the data processing system to data processing system 200. The data processing system providing program code 238 may be a server computer, a client computer, or some other device capable of storing and transmitting program code 238.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 244 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Currently, no method exists that measures quality of data partitions corresponding to a historical data set and notifies a user when the quality of the data partitions is below a quality threshold level. Illustrative embodiments provide data partitioning that ensures variable distribution of each data subset of a particular data partition of the historical data set is similar (i.e., as close as possible) to that of the historical data set (i.e., to provide variable distribution consistency). Illustrative embodiments also provide a quality score for each data partition corresponding to the historical data set, leading to recommendations as to whether a data partition can be used directly to build a supervised machine learning model or whether more data should be collected to increase the quality of the partitions.

When illustrative embodiments evaluate each data partition for quality, illustrative embodiments project variables of the historical data set and variables of each subset of data of a partition (e.g., training, validation, and testing data subsets) to a single variable randomly. Then, illustrative embodiments utilize a statistical test, such as, for example, a two sample Kolmogorov-Smirnov test, to test whether the distributions of projected variables between the historical data set and each subset of data of the partition are similar or not. The two sample Kolmogorov-Smirnov test is a general nonparametric test for comparing two samples. The two sample Kolmogorov-Smirnov test is sensitive to differences in both location and shape of the empirical cumulative distribution functions of the two samples. Based on the significant p-values of the statistical test, illustrative embodiments compute a distribution similarity measure between the variable projections of the historical data set and each subset of data of the partition. A p-value is the probability that a variate would assume a value greater than or equal to the observed value strictly by chance. Illustrative embodiments repeat the projection process M number of times. Afterward, illustrative embodiments average the distribution similarity measures of the M number of projections. Illustrative embodiments utilize the average distribution similarity measure as a quality score for the data partition.

As an example scenario, illustrative embodiments perform K number of random data partitions on the whole historical data set according to a percentage of training, validation, and testing data subsets, which are specified by a user. Across all data variables, illustrative embodiments perform M number of random variable projections. During each projection, illustrative embodiments generate random weights for each variable to form a weighted linear combination. Illustrative embodiments utilize the weighted linear combination to generate a single new variable for variables corresponding to each of the historical data set, the training data subset, the validation data subset, and the testing data subset, respectively. For each projection, the distribution similarity measure is the average of the distribution similarity measures for the single new variable corresponding to each of the data subsets versus the historical data set. The quality score of the partition is the average of the distribution similarity measures from the M number of random projections. Illustrative embodiments generate a partition summary table that provides a highest-quality data partition recommendation for building, validating, and testing a supervised machine learning model. However, if the highest-quality partition score is not greater than a minimum partition quality score threshold, then illustrative embodiments recommend that more data be collected.

As a result, illustrative embodiments are capable of determining whether each data subset of a particular data partition corresponding to the historical data set has a similar variable distribution as the historical data set. In addition, illustrative embodiments are capable of working with categorical variables and continuous variables. However, it should be noted that illustrative embodiments utilize an encoding technique to convert categorical variables to continuous variables before data partitioning. For example, illustrative embodiments may utilize one-hot encoding, which encodes a categorical variable to several 0/1 dummy variables, where 1 in a dummy variable means a particular category is present and 0 means the particular category is not present. Further, illustrative embodiments provide quality scores for each data partition corresponding to the historical data set, which may assist users in understanding whether a particular data partition can be used directly to build a supervised machine learning model corresponding to the historical data set or whether more data should be collected to increase quality of data partitions. Furthermore, illustrative embodiments are capable of identifying quality data partitions corresponding to a historical data set and recommending a highest-quality data partition to the user for building the supervised machine learning model. Moreover, illustrative embodiments may automatically utilize the highest-quality data partition to build, validate, and test the supervised machine learning model corresponding to the historical data set. Thus, illustrative embodiments are capable of increasing performance of the supervised machine learning model corresponding to the historical data set by utilizing the highest-quality data partition to build, validate, and test the supervised machine learning model, which enables the supervised machine learning model to predict unseen data more effectively.

Therefore, illustrative embodiments provide one or more technical solutions that overcome a technical problem with building an effective supervised machine learning model corresponding to a particular historical data set. As a result, these one or more technical solutions provide a technical effect and practical application in the field of supervised machine learning model building.

With reference now to FIG. 3, a diagram illustrating an overview of data partition recommendation process is depicted in accordance with an illustrative embodiment. Data partition recommendation process overview 300 may be implemented in a computer, such as, for example, server 104 in FIG. 1 or data processing system 200 in FIG. 2.

Data partition recommendation process overview 300 starts with historical data set 302, such as, for example, historical data set 220 in FIG. 2. At 304, data partition recommendation process overview 300 performs random partitioning of historical data 302 “K” number of times. K may represent any whole number, such as, for example, 5, 10, 20, or the like. For example, data partition recommendation process overview 300 partitions historical data 302 into data partition 1, data partition 2, and so on, up to data partition K. At step 304, a user needs to specify the number of the times to partition historical data 302, as well as the percentages of historical data 302 to include in each data subset (e.g., training data subset, validation data subset, and testing data subset) of a partition. Then, data partition recommendation process overview 300 randomly partitions historical data 302 K number of times independently.

At 306, data partition recommendation process overview 300 performs quality evaluations of each data partition. For example, data partition recommendation process overview 300 performs a quality evaluation for data partition 1, a quality evaluation for data partition 2, and so on, up to a quality evaluation for data partition K. Data partition recommendation process overview 300 performs a quality evaluation for a data partition by computing a distribution similarity measure between variables of historical data set 302 and variables of each respective data subset of the data partition. Data partition recommendation process overview 300 uses the distribution similarity measures of the data subsets of the data partition to generate a quality score for that data partition.

At 308, data partition recommendation process overview 300 generates a data partition recommendation by identifying a data partition having a highest quality score. Data partition recommendation process overview 300 may provide data partition recommendation 308 to a user for review or may automatically implement data partition recommendation 308 to build, validate, and test a supervised machine learning model corresponding to historical data set 302.

With reference now to FIG. 4, a diagram illustrating an example of a data partition process is depicted in accordance with an illustrative embodiment. Data partition process 400 illustrates partitioning historical data set 402 into one data partition, such as data partition 404. Historical data set 402 may be, for example, historical data set 220 in FIG. 2 or historical data set 302 in FIG. 3.

Historical data set 402 includes variables 406, such as variables 222 in FIG. 2. Variables 406 may represent any variables corresponding to the entity that owns historical data set 402. It should be noted that each column in each table is one variable, such as X1, X2, X3, . . . Xn. In addition, variables 406 may be categorical variables or continuous variables. In this example, data partition 404 includes training data subset 408, validation data subset 410, and testing data subset 412. However, it should be noted that data partition 404 is meant as an example only and not as a limitation of different illustrative embodiments. In other words, data partition 404 may include more or fewer data subsets than shown. In addition, it should be noted that training data subset 408 includes a specified variable percentage of historical data set 402, validation data subset 410 includes another specified variable percentage of historical data set 402, and testing data subset 412 includes yet another specified variable percentage of historical data set 402.

With reference now to FIG. 5, a diagram illustrating an example of a partition quality evaluation process is depicted in accordance with an illustrative embodiment. Partition quality evaluation process 500 illustrates an evaluation of a particular data partition, such as, for example, data partition 404 in FIG. 4, for quality. In this example, partition quality evaluation process 500 includes historical data set 502, training data subset 504, validation data subset 506, and testing data subset 508, such as, for example, historical data set 402, training data subset 408, validation data subset 410, and testing data subset 412 in FIG. 4.

Historical data set 502 includes variables 510, such as, for example, variables 406 in FIG. 4, as well as, training data subset 504, validation data subset 506, and testing data subset 508. Across all X variables in historical data set 502, training data subset 504, validation data subset 506, and testing data subset 508, partition quality evaluation process 500 performs random projections. During each projection, partition quality evaluation process 500 generates random weights (e.g., W1, W2, W3, . . . Wn) for each variable to form a weighted linear combination, such as weighted linear combination 512 (W1*X1+W2*X2+W3*X3+ . . . Wn*Xn), for each projection. Weighted linear combination 512 leads to a single new variable, such as new variable X for historical data set 514, new variable X for training data subset 516, new variable X for validation data subset 518, and new variable X for testing data subset 520, for each of historical data set 502, training data subset 504, validation data subset 506, and testing data subset 508, respectively.

With reference now to FIG. 6, a diagram illustrating an example of a variable distribution similarity measuring process is depicted in accordance with an illustrative embodiment. Variable distribution similarity measuring process 600 measures a level or degree of distribution similarity between variables. For example, variable distribution similarity measuring process 600 starts with new variable from historical data set 602, new variable from training data subset 604, new variable from validation data subset 606, and new variable from testing data subset 608, such as, for example, new variable X for historical data set 514, new variable X for training data subset 516, new variable X for validation data subset 518, and new variable X for testing data subset 520 in FIG. 5.

At 610, variable distribution similarity measuring process 600 measures the distribution similarity between new variable from historical data set 602 and new variable from training data subset 604. In addition, at 612, variable distribution similarity measuring process 600 measures the distribution similarity between new variable from historical data set 602 and new variable from validation data subset 606. Further, at 614, variable distribution similarity measuring process 600 measures the distribution similarity between new variable from historical data set 602 and new variable from testing data subset 608.

Variable distribution similarity measuring process 600 may utilize a statistical test, such as, for example, a two sample Kolmogorov-Smirnov test, to test whether the distribution of the new variable from each data subset is similar to that in the historical data set. The two sample Kolmogorov-Smirnov test is used to test whether two samples come from the same distribution. For example, assume that a first sample from random variable X of x₁, x₂, . . . xₘ of size m has a variable distribution with a cumulative distribution function F(x) and a second sample from random variable Y of y₁, y₂, . . . yₙ of size n has a variable distribution with a cumulative distribution function G(x). A cumulative distribution function of a real-valued random variable X, evaluated at x, is the probability that X will take a value less than or equal to x. Illustrative embodiments test the null hypothesis H₀: F=G vs. H₁:F≠G.

If Fₘ(x) and Gₙ(x) are corresponding empirical cumulative distribution functions, then the Kolmogorov-Smirnov statistic is as follows:

$${D}_{mn} = {( \frac{mn}{m + n} )}^{\frac{1}{2}} {x}^{sup} \vert {F}_{m} ( x ) - {G}_{n} ( x ) \vert ,$$

where

$${x}^{sup}$$

is the supremum of the set of distances. Based on the Kolmogorov-Smirnov statistic Dₘₙ, illustrative embodiments compute the significant p-value from the distribution of Dₘₙ. If the p-value is smaller than a specified threshold level, then illustrative embodiments determine that the variable distribution of F(x) is not the same or similar to the variable distribution of G(x). Otherwise, illustrative embodiments accept that the two variable distributions are the same or similar. Consequently, illustrative embodiments utilize the p-value as the distribution similarity measure of the two samples.

At 616, variable distribution similarity measuring process 600 averages the distribution similarity measures obtained at 610, 612, and 614 for the new variable from the data subsets versus the new variable from the historical data set to obtain the distribution similarity measure for the corresponding data partition, such as, for example, data partition 404 in FIG. 4, for one random projection. Because variable distribution similarity measuring process 600 performs M number of random projections for one data partition, variable distribution similarity measuring process 600 obtains M number of averages for the distribution similarity measure. Variable distribution similarity measuring process 600 may utilize mean, median, or other methods, such as z-score, which is a mean divided by a standard deviation or mean divided by a range (e.g., interquartile range), of the M number of averages for the distribution similarity measure to determine the quality score for the corresponding data partition.

With reference now to FIG. 7, a diagram illustrating an example of a data partition summary table is depicted in accordance with an illustrative embodiment. Data partition summary table 700 may be, for example, partition summary table 236 in FIG. 2. In this example, data partition summary table 700 includes partition identifier 702, similarity measure of training data subset 704, similarity measure of validation data subset 706, similarity measure of testing data subset 708, quality score of partition 710, and partition recommendation 712.

Partition identifier 702 uniquely identifies each particular data partition corresponding to a historical data set, such as, for example, historical data set 502 in FIG. 5. Similarity measure of training data subset 704 shows the level or degree of variable distribution similarity between a training data subset, such as, for example, training data subset 504 in FIG. 5, of that particular data partition with the historical data set. Similarity measure of validation data subset 706 shows the level or degree of variable distribution similarity between a validation data subset, such as, for example, validation data subset 506 in FIG. 5, of that particular data partition with the historical data set. Similarity measure of testing data subset 708 shows the level or degree of variable distribution similarity between a testing data subset, such as, for example, testing data subset 508 in FIG. 5, of that particular data partition with the historical data set.

Quality score of partition 710 shows the quality score corresponding to each particular data partition. In this particular example, the quality score is the average of the distribution similarity measures. Partition recommendation 712 identifies a given data partition that should be used to build, validate, and test a supervised machine learning model corresponding to the historical data set. In this particular example, data partition “1”, which has the highest quality score of “0.85”, is recommended. However, it should be noted that if the highest quality score in the table is less than a defined quality score threshold level, then illustrative embodiments may recommend that the user add more data to improve data partition quality.

With reference now to FIG. 8, a flowchart illustrating a process for recommending a quality data partition for building a supervised machine learning model is shown in accordance with an illustrative embodiment. The process shown in FIG. 8 may be implemented in a computer, such as, for example, server 104 in FIG. 1 or data processing system 200 in FIG. 2.

The process begins when the computer receives an input to build a supervised machine learning model corresponding to a historical data set (step 802). In response to receiving the input in step 802, the computer partitions the historical data set into a specified number of partitions (step 804). Each partition in the specified number of partitions includes a specified number of data subsets. The specified number of data subsets may be, for example, three, such as a training data subset, a validation data subset, and a testing data subset. Each data subset in the specified number of data subsets includes a specified percentage of the historical data set, such as, for example, 60% of the historical data set is included in the training data subset, 20% of the historical data set is included in the validation data subset, and 20% of the historical data set is included in the testing data subset.

After partitioning the historical data set into the specified number of partitions in step 804, the computer evaluates a quality of each partition in the specified number of partitions by measuring a distribution similarity between variables from each data subset in a respective partition and the historical data set (step 806). Subsequently, the computer recommends a highest-quality partition in the specified number of partitions to build the supervised machine learning model based on the highest-quality partition having a highest variable distribution similarity measure with the historical data set (step 808). Thereafter, the process terminates.

With reference now to FIGS. 9A-9C, a flowchart illustrating a process for evaluating data partition quality is shown in accordance with an illustrative embodiment. The process shown in FIGS. 9A-9C may be implemented in a computer, such as, for example, server 104 in FIG. 1 or data processing system 200 in FIG. 2.

The process begins when the computer receives an input to build a supervised machine learning model corresponding to a historical data set (step 902). In addition, the computer receives inputs from a user of a client device specifying a number of times to randomly partition the historical data set, a number of data subsets to divide the historical data set into, and a percentage of the historical data set to include in each corresponding data subset of the historical data set (step 904). Further, the computer retrieves the historical data set from storage (step 906).

Afterward, the computer randomly partitions the historical data set the specified number of times to generate a set of data partitions divided into the specified number of data subsets according to the percentage specified for each respective data subset (step 908). The computer then selects a data partition from the set of data partitions (step 910).

The computer also performs a random projection of a specified number of random projections for all variables of the historical data set and for all variables of each respective data subset in the selected data partition (step 912). During the projection, the computer generates a random weight for all of the variables of the historical data set and for all of the variables of each respective data subset in the selected data partition to form a weighted linear combination for the projection corresponding to the historical data set and each respective data subset (step 914). Moreover, the computer generates a single new variable for all of the variables of the historical data set and for all of the variables of each respective data subset in the selected data partition based on the weighted linear combination of the projection corresponding to the historical data set and each respective data subset (step 916).

In addition, the computer calculates a distribution similarity measure between the single new variable of the historical data set and each respective data subset in the selected data partition based on significant p values of a statistical test that measured a distribution similarity between the single new variable of the historical data set and each respective data subset (step 918). Furthermore, the computer averages distribution similarity measures of the specified number of subsets in the selected data partition to form an average distribution similarity measure for the random projection (step 920).

The computer makes a determination as to whether another random projection of the specified number of random projections needs to be performed (step 922). If the computer determines that another random projection of the specified number of random projections does need to be performed, yes output of step 922, then the process returns to step 912 where the computer performs another random projection. If the computer determines that another random projection of the specified number of random projections does not need to be performed, no output of step 922, then the computer collects all average distribution measures for the specified number of random projections to form a specified number of average distribution similarity measures (step 924). Subsequently, the computer calculates a partition quality score for the selected data partition based on one of a mean, median, or z-score of the specified number of average distribution similarity measures (step 926).

Then, the computer makes a determination as to whether another data partition exists in the set of data partitions (step 928). If the computer determines that another data partition does exist in the set of data partitions, yes output of step 928, then the process returns to step 910 where the computer selects another data partition. If the computer determines that another data partition does not exist in the set of data partitions, no output of step 928, then the computer selects a particular data partition in the set of data partitions having a highest partition quality score (step 930).

Afterward, the computer makes a determination as to whether the highest partition quality score is greater than a minimum partition quality score threshold (step 932). If the computer determines that the highest partition quality score is greater than the minimum partition quality score threshold, yes output of step 932, then the computer uses the particular data partition having the highest partition quality score to build the supervised machine learning model corresponding to the historical data set (step 934) and the process terminates thereafter. If the computer determines that the highest partition quality score is less than or equal to the minimum partition quality score threshold, no output of step 932, then the computer sends a recommendation to the user to include more data in the set of data partitions (step 936). Thereafter, the process terminates.

Thus, illustrative embodiments of the present invention provide a computer-implemented method, computer system, and computer program product for evaluating quality of data partitions to determine whether variable distribution of each partition data subset is similar to a historical data set using distribution similarity measures to recommend a highest-quality data partition to build, validate, and test a supervised machine learning model corresponding to the historical data set. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for evaluating data partition quality, the computer-implemented method comprising:
partitioning, by a computer, a historical data set into a specified number of partitions;
evaluating, by the computer, a quality of each partition in the specified number of partitions by measuring a distribution similarity between variables from each data subset in a respective partition and the historical data set; and
recommending, by the computer, a highest-quality partition in the specified number of partitions to build a supervised machine learning model based on the highest-quality partition having a highest variable distribution similarity measure with the historical data set.

2. The computer-implemented method of claim 1 further comprising:
randomly partitioning, by the computer, the historical data set a specified number of times to generate the specified number of partitions divided into a specified number of data subsets according to a percentage specified for each respective data subset.

3. The computer-implemented method of claim 1 further comprising:
performing, by the computer, a projection of a specified number of projections for variables of the historical data set and for variables of each data subset; and
generating, by the computer, during the projection, a random weight for the variables of the historical data set and for the variables of each data subset to form a weighted linear combination for the projection.

4. The computer-implemented method of claim 1 further comprising:
generating, by the computer, a single new variable for variables of the historical data set and for variables of each data subset based on a weighted linear combination of a projection corresponding to the historical data set and each data subset;
calculating, by the computer, a distribution similarity measure between the historical data set and each data subset based on significant p values of a statistical test that measured the distribution similarity between the single new variable of the historical data set and each data subset; and
averaging, by the computer, distribution similarity measures of the specified number of data subsets to form an average distribution similarity measure for the projection.

5. The computer-implemented method of claim 4 further comprising:
collecting, by the computer, average distribution measures for a specified number of projections to form a specified number of average distribution similarity measures; and
calculating, by the computer, a partition quality score for a selected data partition based on one of a mean, median, or z-score of the specified number of average distribution similarity measures.

6. The computer-implemented method of claim 1 further comprising:
selecting, by the computer, a particular partition having a highest partition quality score; and
determining, by the computer, whether the highest partition quality score is greater than a minimum partition quality score threshold.

7. The computer-implemented method of claim 6 further comprising:
responsive to the computer determining that the highest partition quality score is greater than the minimum partition quality score threshold, using, by the computer, the particular partition having the highest partition quality score to build, validate, and test the supervised machine learning model corresponding to the historical data set.

8. The computer-implemented method of claim 6 further comprising:
responsive to the computer determining that the highest partition quality score is less than or equal to the minimum partition quality score threshold, sending, by the computer, a recommendation to a user to include more data in the set of data partitions to increase partition quality.

9. The computer-implemented method of claim 1, wherein each partition in the specified number of partitions includes a specified number of data subsets, and wherein each data subset in the specified number of data subsets includes a specified percentage of the historical data set.

10. The computer-implemented method of claim 1, wherein variables from each data subset and the historical data set are one of categorical variables and continuous variables.

11. A computer system for evaluating data partition quality, the computer system comprising:
a bus system;
a storage device connected to the bus system, wherein the storage device stores program instructions; and
a processor connected to the bus system, wherein the processor executes the program instructions to:
partition a historical data set into a specified number of partitions;
evaluate a quality of each partition in the specified number of partitions by measuring a distribution similarity between variables from each data subset in a respective partition and the historical data set; and
recommend a highest-quality partition in the specified number of partitions to build a supervised machine learning model based on the highest-quality partition having a highest variable distribution similarity measure with the historical data set.

12. The computer system of claim 11, wherein the processor further executes the program instructions to:
randomly partition the historical data set a specified number of times to generate the specified number of partitions divided into a specified number of data subsets according to a percentage specified for each respective data subset.

13. The computer system of claim 11, wherein the processor further executes the program instructions to:
perform a projection of a specified number of projections for variables of the historical data set and for variables of each data subset; and
generate, during the projection, a random weight for the variables of the historical data set and for the variables of each data subset to form a weighted linear combination for the projection.

14. The computer system of claim 11, wherein the processor further executes the program instructions to:
generate a single new variable for variables of the historical data set and for variables of each data subset based on a weighted linear combination of a projection corresponding to the historical data set and each data subset;
calculate a distribution similarity measure between the historical data set and each data subset based on significant p values of a statistical test that measured the distribution similarity between the single new variable of the historical data set and each data subset; and
average distribution similarity measures of the specified number of data subsets to form an average distribution similarity measure for the projection.

15. The computer system of claim 14, wherein the processor further executes the program instructions to:
collect average distribution measures for a specified number of projections to form a specified number of average distribution similarity measures; and
calculate a partition quality score for a selected data partition based on one of a mean, median, or z-score of the specified number of average distribution similarity measures.

16. A computer program product for evaluating data partition quality, the computer program product comprising a computer readable storage medium having program instructions embodied therewith, the program instructions executable by a computer to cause the computer to perform a method comprising:
partitioning, by the computer, a historical data set into a specified number of partitions;
evaluating, by the computer, a quality of each partition in the specified number of partitions by measuring a distribution similarity between variables from each data subset in a respective partition and the historical data set; and
recommending, by the computer, a highest-quality partition in the specified number of partitions to build a supervised machine learning model based on the highest-quality partition having a highest variable distribution similarity measure with the historical data set.

17. The computer program product of claim 16 further comprising:
randomly partitioning, by the computer, the historical data set a specified number of times to generate the specified number of partitions divided into a specified number of data subsets according to a percentage specified for each respective data subset.

18. The computer program product of claim 16 further comprising:
performing, by the computer, a projection of a specified number of projections for variables of the historical data set and for variables of each data subset; and
generating, by the computer, during the projection, a random weight for the variables of the historical data set and for the variables of each data subset to form a weighted linear combination for the projection.

19. The computer program product of claim 16 further comprising:
generating, by the computer, a single new variable for variables of the historical data set and for variables of each data subset based on a weighted linear combination of a projection corresponding to the historical data set and each data subset;
calculating, by the computer, a distribution similarity measure between the historical data set and each data subset based on significant p values of a statistical test that measured the distribution similarity between the single new variable of the historical data set and each data subset; and
averaging, by the computer, distribution similarity measures of the specified number of data subsets to form an average distribution similarity measure for the projection.

20. The computer program product of claim 19 further comprising:
collecting, by the computer, average distribution measures for a specified number of projections to form a specified number of average distribution similarity measures; and
calculating, by the computer, a partition quality score for a selected data partition based on one of a mean, median, or z-score of the specified number of average distribution similarity measures.

21. The computer program product of claim 16 further comprising:
selecting, by the computer, a particular partition having a highest partition quality score; and
determining, by the computer, whether the highest partition quality score is greater than a minimum partition quality score threshold.

22. The computer program product of claim 21 further comprising:
responsive to the computer determining that the highest partition quality score is greater than the minimum partition quality score threshold, using, by the computer, the particular partition having the highest partition quality score to build, validate, and test the supervised machine learning model corresponding to the historical data set.

23. The computer program product of claim 21 further comprising:
responsive to the computer determining that the highest partition quality score is less than or equal to the minimum partition quality score threshold, sending, by the computer, a recommendation to a user to include more data in the set of data partitions to increase partition quality.

24. The computer program product of claim 21, wherein each partition in the specified number of partitions includes a specified number of data subsets, and wherein each data subset in the specified number of data subsets includes a specified percentage of the historical data set.

25. The computer program product of claim 21, wherein variables from each data subset and the historical data set are one of categorical variables and continuous variables.
